(19) United States
(12) Patent Application Publication
(10) Pub. No.: US 2014/0270413 A1
(43) Pub. Date: Sep. 18, 2014

(54) AUXILIARY DEVICE FUNCTIONALITY AUGMENTED WITH FINGERPRINT SENSOR

(71) Applicant: MOTOROLA MOBILITY LLC, Libertyville, IL (US)

(72) Inventors: Jiri Slaby, Buffalo Grove, IL (US); Roger W. Ady, Chicago, IL (US); Rachid M. Alameh, Crystal Lake, IL (US); Chad Austin Phipps, Grayslake, IL (US)

(73) Assignee: MOTOROLA MOBILITY LLC, Libertyville, IL (US)

(21) Appl. No.: 13/832,032

(22) Filed: Mar. 15, 2013

(51) Int. Cl. G06K 9/00

(52) U.S. Cl. CPC G06K 9/00013
USPC 382/124

(57) ABSTRACT

A sensor structure (110) for a device includes both a fingerprint sensor (112) and one or more touch sensors (114). The fingerprint sensor and the touch sensors can sense a user's finger touching the sensor structure, and the fingerprint sensor can also sense fingerprint data identifying a fingerprint pattern on the user's finger. The sensor structure serves as an input mechanism to allow a user to input his or her fingerprint for authentication, and also to allow the user to provide inputs to control auxiliary functionality of the device (e.g., volume control, cursor control, phone call control, etc.). A control system automatically determines whether a fingerprint is being input by the user for authentication or whether auxiliary functionality of the device is being controlled by the user, and based on the determination enables an appropriate one of a fingerprint authentication mode and an auxiliary functionality mode.

### CROSS REFERENCE TO RELATED APPLICATIONS

This application is related to co-owned U.S. patent application Ser. No. ______, docket number CS41366, entitled AUXILIARY FUNCTIONALITY CONTROL AND FINGERPRINT AUTHENTICATION BASED ON A SAME USER INPUT and filed concurrently herewith.

### BACKGROUND

One way in which access to systems or devices can be controlled is through the use of fingerprint authentication, in which a user's fingerprint is captured by a fingerprint sensor and authenticated. However, current fingerprint sensors are not without their problems. One such problem is that fingerprint sensors can occupy a significant amount of space on a device for the single dedicated operation of sensing fingerprints, space which is not available for the device to provide other functionality to the user.

### BRIEF DESCRIPTION OF THE DRAWINGS

Embodiments of auxiliary device functionality augmented with fingerprint sensor are described with reference to the following drawings. The same numbers are used throughout the drawings to reference like features and components:

FIG. 1 illustrates an example device implementing the auxiliary device functionality augmented with fingerprint sensor in accordance with one or more embodiments;

FIG. 2 illustrates a top-down view of an example sensor structure in accordance with one or more embodiments;

FIG. 3 illustrates an example system implementing the auxiliary device functionality augmented with fingerprint sensor in accordance with one or more embodiments;

FIG. 4 illustrates a cross-section view of an example sensor structure in accordance with one or more embodiments;

FIG. 5 illustrates a cross-section view of another example sensor structure in accordance with one or more embodiments;

FIG. 6 illustrates a cross-section view of another example sensor structure in accordance with one or more embodiments;

FIG. 7 illustrates an example device that includes a sensor structure in accordance with one or more embodiments;

FIG. 8 illustrates an example system implementing the auxiliary device functionality augmented with fingerprint sensor in accordance with one or more embodiments;

FIG. 9 illustrates an example process implementing the auxiliary device functionality augmented with fingerprint sensor in accordance with one or more embodiments;

FIG. 10 illustrates an example scenario in which a fingerprint sensor senses the finger touching the sensor structure and the finger is stationary in accordance with one or more embodiments;

FIG. 11 illustrates an example scenario in which a fingerprint sensor senses the finger touching the sensor structure and the finger is moving in accordance with one or more embodiments;

FIG. 12 illustrates an example scenario in which a touch sensor senses the finger touching the sensor structure and the finger is moving in accordance with one or more embodiments;

FIG. 13 illustrates an example scenario in which a touch sensor senses the finger touching the sensor structure and the finger is stationary in accordance with one or more embodiments;

FIGS. 14, 15, 16, 17, 18, 19, 20, 21, 22, and 23 illustrate top-down views of different example sensor structures in accordance with one or more embodiments; and

FIG. 24 illustrates various components of an example electronic device that can implement embodiments of the auxiliary device functionality augmented with fingerprint sensor in accordance with one or more embodiments.

### DETAILED DESCRIPTION

Auxiliary device functionality augmented with fingerprint sensor is discussed herein. A sensor structure for a device includes both a fingerprint sensor and one or more touch sensors. The fingerprint sensor as well as the touch sensors can sense a user's finger touching the sensor structure, but the fingerprint sensor can also sense fingerprint data identifying a fingerprint pattern on the user's finger. The sensor structure serves as an input mechanism to allow a user to input his or her fingerprint for authentication, and also to allow the user to provide inputs to control auxiliary functionality of the device. Various auxiliary functionality of the device can be controlled, such as the volume of audio output by the device, phone call control functionality (e.g., answering or hanging up phones), scrolling or panning through data displayed on the device, zooming in or out of a display of the device, and so forth.

When a user's finger is touching the sensor structure, a control system automatically determines whether a fingerprint is being input by the user or other functionality of the device is being controlled by the user. If a fingerprint is being input by the user, then the fingerprint sensor operates in a high resolution mode and a fingerprint identification module is enabled to authenticate the user's fingerprint. However, if other functionality of the device is being controlled by the user, then the fingerprint sensor operates in a low resolution mode and an auxiliary functionality module is enabled to control the appropriate functionality in response to the user inputs. If the other functionality of the device is being controlled by the user, the fingerprint identification module need not be enabled, and the computational and power expense of authenticating a fingerprint need not be expended even though the user's finger may be touching the fingerprint sensor.

FIG. 1 illustrates an example device 102 implementing the auxiliary device functionality augmented with fingerprint sensor in accordance with one or more embodiments. The device 102 can be any of a variety of different types of devices, such as a laptop computer, a cellular or other wireless phone, a tablet computer, an entertainment device, a wearable device, an audio and/or video playback device, a server computer, and so forth. The device 102 includes a sensor structure 110 having a fingerprint sensor 112, a touch sensor 114, a sensor based control system 116, a fingerprint identification module 118, and an auxiliary functionality module 120.

The fingerprint sensor 112 can sense fingerprint data of a user's finger touching the sensor 112. The fingerprint data identifies a fingerprint's pattern on the finger, typically identifying the location of various ridges and/or minutiae of the fingerprint. The fingerprint sensor 112 can be implemented using any of a variety of different technologies and types of sensors, such as capacitive sensors, pressure sensors, resistive sensors, optical sensors, thermal sensors, acoustic sensors, ultrasonic sensors, imaging sensors, and so forth.

The touch sensor 114 senses a user's finger touching the sensor 114, and the fingerprint sensor 112 senses a user's finger touching the sensor 112. However, the touch sensor 114 differs from the fingerprint sensor 112 in that the touch sensor 114 does not sense fingerprint data of a user's finger touching the sensor 114. The touch sensor 114 can be implemented using any of a variety of different technologies and types of sensors, such as capacitive sensors, pressure sensors, optical sensors, thermal sensors, acoustic sensors, ultrasonic sensors, imaging sensors, and so forth. The touch sensor 114 can be implemented using the same technology and type of sensor as the fingerprint sensor 112, or alternatively using a different technology or type of sensor as the fingerprint sensor 112.

It should be noted that, although the fingerprint sensor 112 and the touch sensor 114 are illustrated in FIG. 1, the device 102 can include any number of fingerprint sensors 112 and any number of touch sensors 114.

It should also be noted that although many of the discussions herein refer to the touch sensor 114 and the fingerprint sensor 112 as sensing a finger, the touch sensors 114 and the fingerprint sensor 112 can optionally sense various other objects. For example, the sensors 112 and 114 may sense a stylus, a pen, a brush, or other object touching the sensors 112 and 114. However, the fingerprint sensor 112 can only sense a fingerprint on an object that has a fingerprint (e.g., a finger). References are made herein to a finger touching the sensors 112 or 114 or moving across the sensors 112 or 114 as examples, and it should be noted that such references also refer to other objects touching or moving across the sensors 112 or 114.

The fingerprint sensor 112 and one or more touch sensors 114 are situated adjacent to one another, and together form the sensor structure 110. One sensor being adjacent to another sensor refers to the two sensors being in physical contact with one another or within a threshold distance (e.g., a few millimeters) of one another. The fingerprint sensor 112 and each touch sensor 114 can each be a physically separate sensor, or alternatively can be separate areas created on a single component, such as a rigid printed circuit board (PCB) or flex PCB, or indium tin oxide (ITO) or other on glass or plastic, or overmolded silicon. FIG. 2 illustrates a top-down view of an example sensor structure 110 in accordance with one or more embodiments. The sensor structure 110 includes the fingerprint sensor 112 adjacent to two touch sensors 114. In the illustrated example of FIG. 2, the fingerprint sensor 112 is situated between the two touch sensors 114, with one touch sensor 114 being situated above the fingerprint sensor 112 and one touch sensor 114 being situated below the fingerprint sensor 112. Various examples of sensor structures 110 are discussed herein, illustrated with rectangular sensors 112 and 114. It should be noted that these are examples, and that a fingerprint sensor 112 can have any shape (e.g., circular, rectangular, triangular, and so forth) and that a touch sensor 114 can have any shape (e.g., circular, rectangular, triangular, and so forth). A touch sensor 114 can have the same shape as the fingerprint sensor 112, or alternatively a different shape.

Returning to FIG. 1, the sensor based control system 116 receives inputs from the fingerprint sensor 112 indicating a finger touching the fingerprint sensor 112. Similarly, the sensor based control system 116 receives inputs from the touch sensor 114 indicating a finger touching the touch sensor 114.

The fingerprint identification module 118 analyzes fingerprint data for a fingerprint sensed by the fingerprint sensor 112 in order to authenticate the fingerprint. To authenticate the fingerprint, the fingerprint data is compared to a fingerprint template. The fingerprint template refers to fingerprint data that has been previously sensed or otherwise obtained (e.g., during an initial enrollment process) and that can be used as valid fingerprint data for the user. The fingerprint template can be stored at the device 102 or at another device accessible to the device 102, and the module 118 uses the fingerprint template to authenticate the fingerprint. It should be noted that fingerprint authentication can be performed by the device 102 for its own use and/or use by another system or device. For example, the fingerprint identification module 118 can authenticate fingerprints in order to allow a user to access the device 102 itself, to allow a user to access programs or applications running on the device 102, to allow a user to access other modules or components of the device 102, to personalize the device 102, to direct access modes of the device 102, and so forth. Alternatively, the fingerprint identification module 118 can authenticate fingerprints in order to allow a user to access another system or device coupled to the device 102, to allow a user to access another system or device accessed by the device 102 via the Internet or other network, and so forth.

The auxiliary functionality module 120 provides auxiliary functionality to the device 102. This auxiliary functionality can take a variety of different forms, and can be any functionality that can be controlled at least in part based on movement of a finger across the sensor structure. In one embodiment, the auxiliary functionality is volume control, and the module 120 increases or decreases the volume level of one or more sounds output by the device 102 in response to movement of a finger across the sensor structure 110. In another embodiment, the auxiliary functionality is call control, and the module 120 answers or ends a phone call (or other communication channel) of for the device 102 in response to movement of a finger across the sensor structure 110. In another embodiment, the auxiliary functionality is cursor control, and the module 120 moves a cursor or other user interface object or component displayed to a user of the device 102 in response to movement of a finger across the sensor structure 110. In other embodiments, the auxiliary functionality module 120 can provide various other functionality based at least in part on movement of a finger across the sensor structure 110, such as capturing photos or videos, capturing audio recordings, scrolling through lists or displays, panning through information displayed on a display of the device 102, zooming in or out of a display of the device 102, menu item switching, and so forth.

FIG. 3 illustrates an example system 300 implementing the auxiliary device functionality augmented with fingerprint sensor in accordance with one or more embodiments. The system 300 includes a device 302 that can be any of a variety of different types, analogous to the discussion of device 102 of FIG. 1. The device 302 is similar to the device 102 of FIG. 1, and includes a sensor based control system 116, a fingerprint identification module 118, and an auxiliary functionality module 120. However, the device 302 differs from the device 102 in that the device 302 does not include the sensor structure 110.

Sensor structure 110 includes a fingerprint sensor 112 and a touch sensor 114. In system 300, the sensor structure 110 is implemented separately from the device 302, and provides data (e.g., indications of a finger touching the fingerprint sensor 112 or the touch sensor 114) to the device 302. This data can be provided via a variety of different communication channels, including wired communication channels, such as Universal Serial Bus (USB) connections, and/or wireless communication channels. Various different wireless communication channels can be used, such as wireless USB channels, Bluetooth channels, WiFi channels, Bluetooth Low Energy (BTLE) channels, near field communication (NFC) channels, TransferJet channels, radio frequency (RF) channels, optical channels, infrared (IR) channels, and so forth. In one or more embodiments, the sensor structure 110 is implemented as a wearable device, such as as part of a watch or other jewelry that communicates with the device 302 implemented as another wearable device.

In the illustrated example of FIG. 3, the sensor based control system 116 is included as part of the device 302. Alternatively, at least part of the sensor based control system 116 can be included in the sensor structure 110. Similarly, at least part of the fingerprint identification module 118 can optionally be included in the sensor structure 110, and at least part of the auxiliary functionality module 120 can optionally be included in the sensor structure 110.

FIG. 4 illustrates a cross-section view of an example sensor structure 110 in accordance with one or more embodiments. The sensor structure 110 includes the fingerprint sensor 112 adjacent to two touch sensors 114, with the touch sensors 114 being illustrated with cross-hatching. In the illustrated example of FIG. 4, the fingerprint sensor 112 is situated between the two touch sensors 114. The fingerprint sensor 112 and each touch sensor 114 can each be a physically separate sensor, or alternatively can be separate areas built onto a single substrate (e.g., be on the same plane of the same material such as rigid PCB or flex PCB, or ITO or other on glass or plastic, or overmolded silicon). The sensor structure 110 also optionally includes one or more additional layers 402 situated on top of the sensor structure 110. The one or more layers 402 can supplement the sensors 112 and 114 in various manners, such as by providing protection from scratches and abrasions, by providing protection from water or other elements, and so forth. It should be noted that the one or more layers 402 are optional and need not be included in sensor structure 110. It should also be noted that, although illustrated as being at the top of the sensor structure 110 or above the fingerprint sensor 112 and the touch sensor 114, one or more additional layers can optionally be included below the fingerprint sensor and the touch sensor 114

A finger 404 touching the sensor structure 110 is also illustrated in FIG. 4. Depending on the location where the finger touches the sensor structure, one of the touch sensors and/or the fingerprint sensor 112 can sense the finger 404 touching the sensor structure 110. In some situations, the fingerprint sensor 112 also senses fingerprint data of the finger 404. It should be noted that in situations in which the sensor structure 110 includes one or more additional layers 402, the touch sensor 114 senses a finger touching the additional layer of the sensor structure 110 above the touch sensor 114 even though the finger is not in physical contact with the touch sensor 114, and the fingerprint sensor 112 senses a finger touching the additional layer of the sensor structure 110 above the fingerprint sensor 112 even though the finger is not in physical contact with the fingerprint sensor 112.

The fingerprint sensor 112 is illustrated as having a different height or depth than the touch sensors 114. The fingerprint sensor 112 can be implemented using different technologies than the touch sensors 114, and thus may be a different size. Despite the different sizes, a top surface (the surface closest to finger 404) of the fingerprint sensor 112 is approximately flush with the top surface (the surface closest to finger 404) of the touch sensors 114, and thus the fingerprint sensor 112 and the touch sensors 114 are also referred to as being in the same plane. By having the top surfaces of sensors 112 and 114 flush with one another, the user is typically not able to feel any separation or difference between sensors 112 and 114 when moving his or her finger across the top surface of the sensor structure 110.

FIG. 5 illustrates a cross-section view of another example sensor structure 110 in accordance with one or more embodiments. Analogous to the sensor structure 110 in FIG. 4, the sensor structure 110 in FIG. 5 includes the fingerprint sensor 112 adjacent to and situated between two touch sensors 114, with the touch sensors 114 being illustrated with cross-hatching. The sensor structure 110 also optionally includes one or more additional layers 402 situated on top of the sensor structure 110.

However, the sensor structure 110 in FIG. 4 differs from the sensor structure 110 in FIG. 5 in that the top surface (the surface closest to finger 404) of the fingerprint sensor 112 of the sensor structure 110 in FIG. 5 is not approximately flush with the top surface (the surface closest to finger 404) of the touch sensors 114. Rather, the top surface of the fingerprint sensor 112 is slightly recessed relative to the top surface of the touch sensors 114 in FIG. 5. Similarly, the area of any additional layers 402 above the fingerprint sensor 112 is slightly recessed relative to the area of any additional layers above the touch sensors 114. Alternatively, the area of any additional layers 402 above the fingerprint sensor 112 may be slightly recessed relative to the area of any additional layers above the touch sensors 114, and a top surface of the fingerprint sensor 112 may be approximately flush with the top surface of the touch sensors 114. The slight recession illustrated in FIG. 5 can be various amounts.

Slightly recessing the top surface of the fingerprint sensor 112 relative to the top surface of the touch sensors 114 allows the user to be able to feel a separation or difference between sensors 112 and 114 when moving his or her finger across the top surface of the sensor structure 110. This difference helps the user quickly locate the portion of the sensor structure 110 where the fingerprint sensor 112 is located, and thus quickly identify where to place his or her finger to have his or her fingerprint data sensed and authenticated. However, the recession is small enough so that the user can still easily move his or her finger smoothly across the top surface of the sensors 112 and 114.

FIG. 6 illustrates a cross-section view of another example sensor structure 110 in accordance with one or more embodiments. Analogous to the sensor structure 110 in FIG. 5, the sensor structure 110 in FIG. 6 includes the fingerprint sensor 112 adjacent to and situated between two touch sensors 114, with the touch sensors 114 being illustrated with cross-hatching. The sensor structure 110 also optionally includes one or more additional layers 402 situated on top of the sensor structure 110.

However, the sensor structure 110 in FIG. 6 differs from the sensor structure 110 in FIG. 5 in that the top surface (the surface closest to finger 404) of the fingerprint sensor 112 of the sensor structure 110 in FIG. 6 is slightly raised relative to the top surface of the touch sensors 114 rather than being slightly recessed. Similarly, the area of any additional layers 402 above the fingerprint sensor 112 is slightly raised relative to the area of any additional layers above the touch sensors 114. Alternatively, the area of any additional layers 402 above the fingerprint sensor 112 may be slightly raised relative to the area of any additional layers above the touch sensors 114, and a top surface of the fingerprint sensor 112 may be approximately flush with the top surface of the touch sensors 114. The slight raising illustrated in FIG. 6 can be various amounts. Similar to the recession in FIG. 5, slightly raising the top surface of the fingerprint sensor 112 relative to the top surface of the touch sensors 114 allows the user to be able to feel a separation or difference between sensors 112 and 114 when moving his or her finger across the top surface of the sensor structure 110.

Alternatively, rather than slightly recessing or raising the top surface of the fingerprint sensor 112 and the area of any additional layers 402 above the fingerprint sensor 112, the area of the sensor structure 110 that includes the fingerprint sensor 112 can be identified to a user in other manners. For example, an additional layer 402 may have a different color or texture for areas above the fingerprint sensor 112 than for areas above the touch sensors 114. By way of another example, an additional layer may include a slight protrusion (e.g., a bump) outward from the top surface of the sensor structure 110 in an area above the fingerprint sensor 112 (e.g., centered above the fingerprint sensor 112).

FIG. 7 illustrates an example device 700 that includes the sensor structure 110 in accordance with one or more embodiments. The device 700 is, for example, a mobile device such as a wireless phone. The sensor structure 110 is implemented on one side of the device 700, such as on the back of the phone. The sensor structure 110 includes a fingerprint sensor situated between two touch sensors (the touch sensors being illustrated with cross-hatching), with one touch sensor being situated above the fingerprint sensor and one touch sensor being situated below the fingerprint sensor analogous to the sensor structure 110 of FIG. 2.

FIG. 8 illustrates an example system 800 implementing the auxiliary device functionality augmented with fingerprint sensor in accordance with one or more embodiments. The system 800 can be implemented by a single device (e.g., the device 102 of FIG. 1) or multiple devices (e.g., the device 302 and a device implementing the sensor structure 110 of FIG. 3). The system 100 includes the sensor structure 110 including one or more touch sensors 114 and one or more fingerprint sensors 112.

Generally, the fingerprint sensor 112 can operate in multiple resolution modes, such as a high resolution mode or a low resolution mode. If a user is touching his or her finger to the fingerprint sensor 112 and his or her finger is stationary, then the fingerprint sensor operates in a high resolution mode and a fingerprint identification module is enabled to authenticate the user's fingerprint. However, if the user is touching his or her finger to the touch sensor 114 and/or the fingerprint sensor 112, and his or her finger is moving, then the fingerprint sensor 112 operates in a low resolution mode and an auxiliary functionality module for the fingerprint sensor 112 is enabled to control the appropriate functionality in response to the user inputs.

When a finger is touching the touch sensor 114, the sensor 114 provides an indication to the sensor based control system 116 of the sensor 114 touched by the finger. The indication can take various forms. In one embodiment, the touch sensor 114 is implemented as a single sensor (also referred to as a discrete sensor), which refers to the sensor 114 being able to detect either that the sensor is being touched or not being touched. In this embodiment, the sensor 114 provides to the control system 116 an indication that either the sensor is being touched or not being touched. In another embodiment, the touch sensor 114 is implemented in a grid-type arrangement that can provide at least some indication of where the sensor is being touched (as opposed to simply that the sensor is being touched or not being touched). In the grid-type arrangement, a small number (e.g., a few per inch) of pixels or nodes of the sensor 114 are activated for sensing touch. In this embodiment, the sensor 114 provides to the control system 116 an indication of where the sensor is being touched, such as one or more coordinates (e.g., using a Cartesian coordinate system) on the sensor 114 that are touched, and so forth.

The fingerprint sensor 112 can operate in multiple different resolution modes, such as a high resolution mode and a low resolution mode. Although two resolution modes are discussed herein, it should be noted that the fingerprint sensor 112 can operate in any number of different resolution modes (e.g., as also shown in the FIGs. later where there is high resolution, a low resolution, and a single or discrete touch sensor). The fingerprint sensor 112 is implemented in a grid-type arrangement that is capable of reproducing a fingerprint image or characteristics.

When operating in the high resolution mode, a large number (e.g., hundreds per inch) of pixels or nodes of the sensor 112 are activated for sensing touch. The high resolution mode thus provides fine sensing for sensing fingerprint data. However, when operating in the low resolution mode, a smaller number (e.g., a few per inch) of pixels or nodes of the sensor 112 are activated for sensing touch. In the low resolution mode, the sensor 112 can optionally be operating as a discrete sensor. The low resolution mode thus provides coarse sensing for controlling auxiliary functionality. It should be noted that although coarse sensing is provided in the low resolution mode, power consumption in the low resolution mode is less than in the high resolution mode due to the smaller number of pixels or nodes of the sensor 112 that are activated for sensing touch.

Regardless of whether the fingerprint sensor 112 is operating in the high resolution mode or the low resolution mode, when a finger is touching the fingerprint sensor 112 the sensor 112 provides an indication to the sensor based control system 116 of the sensor 112 being touched by the finger. The indication can be an identification of where the sensor is being touched, such as one or more coordinates (e.g., using a Cartesian coordinate system) on the sensor 112 that are touched. When operating in the low resolution mode, the fingerprint sensor may operate as a discrete touch sensor, being able to detect either that the sensor is being touched or not being touched but any indication of where the sensor 112 is being touched.

Thus, each of the sensors 112 and 114 provides an indication to the sensor based control system 116 when the sensor is being touched, as well as possibly an indication of where the sensor is being touched. As long as the sensor is being touched, the sensor provides at regular or irregular intervals these indications to the system 116. When a sensor is no longer being touched, the sensor ceases providing these indications to the system 116.

The system 116 also obtains an indication of which of the fingerprint sensor 112 and/or the touch sensor 114 was touched. The system 116 can obtain this indication in various manners, such as receiving indications of touch from different communication channels or signals for the sensor 112 than for the sensor 114 (thus allowing the system 116 to readily determine which sensor provided the indication of a touch based on the communication channel or signal on which the indication is received). Alternatively, the system 116 can obtain this indication in other manners, such as an identifier of the sensor providing the indication that a sensor was touched being included with the indication of the touch.

Timing information indicating the time at which a finger is sensed by the fingerprint sensor 112 or the touch sensor 114 is also obtained by the sensor based control system 116. The timing information can take various forms, such as a timestamp (e.g., in hours, minutes, seconds, and milliseconds) of a time of day that the finger is sensed by the sensor, an amount of time that has elapsed since the last indication of a sensed finger was provided by the sensor, and so forth. The timing information is associated with an indication of a touched sensor 112 or 114, and optionally where the sensor was touched, and can be obtained by the control system 116 in various manners, such as being included by the sensor 112 or 114 along with the indication that the sensor is being touched, being generated by the control system 116 when the indication that the sensor is being touched is received from the sensor 112 or 114, and so forth.

Movement detection module 802 determines whether a finger is moving across the sensor structure 110. The module 802 can make this determination based on the sensors 112 and/or 114 that are being touched, and optionally where the sensors 112 and/or 114 are being touched, as well as the timing of those touches. For example, the module 802 can determine that if at least a threshold number of sensors 112 and/or 114 that are sensed as being touched changes within a threshold amount of time, then the finger is moving across the sensor structure 110. By way of another example, the module 802 can determine that if at least a threshold number of the indicated nodes of where the sensors 112 and/or 114 are being touched change within a threshold amount of time, then the finger is moving across the sensor structure. By way of another example, the module 802 can determine that if both the touch sensor 114 senses the finger touching the sensor 114 and the fingerprint sensor 112 senses the finger touching the sensor 112 within a threshold amount of time, then the finger is moving across the sensor structure. By way of another example, the module 802 can make the determination of whether a finger is moving across the sensor structure 110 by comparing images gained or generated by the fingerprint sensor 112 over time. If a finger is touching the sensor structure 110 and it is determined that the finger is not moving across the sensor structure 110, the finger is also referred to as being stationary.

Movement detection module 802 optionally determines a pattern of movement, such as a direction of movement, a shape of the movement, and so forth. The pattern of movement can be readily determined based on the indications of which of, and optionally the indications of where, the sensors 112 and/or 114 are being touched and the order of the touching (e.g., as identified by the order in which the indications of touches are received from the sensor structure 110 or the timing information associated with the indications of the touches). Alternatively, the auxiliary functionality module 120 can determine the pattern of movement rather than the movement detection module 802. In such situations, the indications of which of, and optionally the indications of where, the sensors 112 and/or 114 are being touched and optionally the timing information associated with the indications of the touches is provided to the module 120 to allow the module 120 to determine the pattern of movement.

In one embodiment, the default mode of the fingerprint sensor 112 is the low resolution mode. The fingerprint sensor 112 operates in the low resolution mode until the fingerprint sensor 112 detects an object touching the sensor 112 and the object is stationary (e.g., not moving for at least a threshold amount of time). In response to the fingerprint sensor 112 detecting the stationary object touching the sensor 112, the control system 116 activates the high resolution mode of fingerprint sensor 112 to sense the fingerprint of the object and provide the sensed fingerprint to the fingerprint identification module 118 for authentication. When the module 118 ceases the authentication process, or the object is no longer touching the fingerprint sensor 112, the control system 116 activates the low resolution mode of the fingerprint sensor 112. Thus, in this embodiment, the fingerprint sensor remains in the low resolution mode until an attempt to authenticate a fingerprint is detected.

In another embodiment, the default mode of the fingerprint sensor 112 is the high resolution mode. The fingerprint sensor 112 operates in the high resolution mode until the fingerprint sensor 112 and/or the touch sensor 114 detects an object touching the sensor structure 110 and the object is moving across the sensor structure 110. In response to the sensor 112 and/or 114 detecting the moving object touching the sensor structure 110, the control system 116 activates the low resolution mode of fingerprint sensor 112 to sense movement of the object as providing user input to control auxiliary functionality. When the auxiliary functionality module 120 ceases performing the auxiliary functionality, or the object is no longer touching the sensor 112 or 114, the control system 116 activates the high resolution mode of the fingerprint sensor 112. Thus, in this embodiment, the fingerprint sensor remains in the high resolution mode until an attempt to provide user input to control auxiliary functionality is detected.

Mode selection module 804 determines, based on which of the sensors 112 and 114 is touched as well as whether a finger is moving across the sensor structure 110, whether the system 800 is to operate in an authentication mode or an auxiliary functionality mode. In response to a determination that the system 800 is operating in the authentication mode, the module 804 enables the authentication mode. In enabling the authentication mode, the module 804 activates the fingerprint sensor 112 to operate in the high resolution mode if the fingerprint sensor 112 is not already operating in the high resolution mode. The module 804 also enables or activates the fingerprint identification module 118 (including various hardware, software, and/or firmware components, such as processors, algorithms, and so forth) to attempt to authenticate a fingerprint of the finger touching the sensor structure 110.

In the authentication mode, the fingerprint sensor 112 senses a pattern of a user's fingerprint and provides fingerprint data identifying this pattern to the sensor based control system 116, which provides the fingerprint data to the fingerprint identification module 118. Alternatively, the fingerprint sensor 112 can provide the fingerprint data to the fingerprint identification module 118 directly rather than through the control system 116.

The fingerprint data identifies a pattern of a user's fingerprint that was sensed or detected by the fingerprint sensor 112. In one embodiment, this fingerprint data is an indication of the locations where minutiae and/or ridges of the fingerprint are sensed or identified by the fingerprint sensor 112. The locations can be identified in various different manners, such as using a 2-dimensional Cartesian coordinate system in which the locations where minutiae or ridges are sensed are identified using x,y coordinates. An example of a 2-dimensional Cartesian coordinate system is illustrated in FIG. 2, with a y axis 202 and an x axis 204. Alternatively, other coordinate systems can be used, such as Polar coordinate systems, proprietary coordinate systems, and so forth.

The fingerprint identification module 118 receives fingerprint data, also referred to as a sensed fingerprint image, from the fingerprint sensor 112. The fingerprint identification module 118 analyzes the sensed fingerprint data and compares it to the fingerprint template for the user. The fingerprint template can be stored in the same device as implements the fingerprint identification module 118, or alternatively can be stored in a separate device (e.g., accessible to the fingerprint identification module 118 via any of a variety of data networks). The fingerprint template for the user's finger can be stored at various times, such as during an initial enrollment process, which refers to a process during which the user is setting up or initializing the fingerprint identification module 118 to authenticate his or her fingerprint.

The fingerprint identification module 118 compares the sensed fingerprint to the fingerprint template, and based on this comparison the fingerprint identification module 118 determines whether the sensed fingerprint satisfies the fingerprint template. When the fingerprint satisfies the fingerprint template (e.g., the fingerprint data matches the fingerprint template), the fingerprint authentication succeeds and the fingerprint (and the user) is authenticated. When the fingerprint does not satisfy the fingerprint template (e.g., the fingerprint data does not match the fingerprint template), the fingerprint authentication fails and the fingerprint (and the user) is not authenticated. The fingerprint identification module 118 can make this comparison in different manners in accordance with various different embodiments. In one embodiment, the fingerprint identification module 118 compares the sensed fingerprint data to the fingerprint template and determines whether the sensed fingerprint data matches the fingerprint template for the user.

The fingerprint identification module 118 can determine whether the sensed fingerprint data and the fingerprint template match in various different manners. In one embodiment, the locations where minutiae or ridges are detected as indicated in the sensed fingerprint data and the fingerprint template are compared. If the number of corresponding locations in the sensed fingerprint data and the fingerprint template where minutiae or ridges are detected satisfies (e.g., is equal to and/or greater than) a threshold value, the sensed fingerprint data and the fingerprint template match; otherwise, the sensed fingerprint data and the fingerprint template do not match. Various different correlation or alignment techniques can be used to align the two fingerprint data so that corresponding features (e.g., at the same coordinates relative to an origin or other reference point) can be readily identified. Alternatively, various other public and/or proprietary pattern matching techniques can be used to determine whether the sensed fingerprint data and the fingerprint template match.

However, if mode selection module 804 determines that the system 800 is to operate in the auxiliary functionality mode rather than the authentication mode, then in response to this determination the module 804 enables the auxiliary functionality mode. In enabling the auxiliary functionality mode, the module 804 activates the fingerprint sensor 112 to operate in the low resolution mode if the fingerprint sensor 112 is not already operating in the low resolution mode. The module 804 also enables or activates the auxiliary functionality module 120 (including various hardware, software, and/or firmware components, such as processors, algorithms, and so forth) to control auxiliary functionality of a device based on movement of the finger across the sensor structure 110. The pattern of movement of the user's finger across the sensor structure 110 is used by the auxiliary functionality module to determine the function or operation being requested by the user.

Various different auxiliary functionality can be controlled by the auxiliary functionality module 120. Generally, the auxiliary functionality refers to any functionality that can be controlled by user inputs to the sensor structure 110. These user inputs typically include the user's finger moving across the sensor structure 110 in a line, circle, or any other pattern. The particular pattern used to indicate a particular user input can vary by implementation, and can be enabled by sensor design and capability. Additionally, the pattern can be an approximate pattern. For example, if the pattern is to be a line that is vertical or along the y axis in a Cartesian coordinate system (e.g., the axis 202 of FIG. 2), then a user input that is a line, for example, within a certain angle from the y axis may be sufficient to indicate the particular input, other patterns (e.g., wave direction, zig-zag, etc.) may be sufficient as well to indicate the particular input as far as they follow substantially the direction along the y axis across the particular segments. Furthermore, the particular pattern used to indicate a particular input may be user-configurable, allowing a user to choose from one of a set of multiple patterns or allowing the user to customize the pattern to be any pattern he or she desires. Although specific examples of auxiliary functionality are discussed herein, it should be noted that the techniques discussed herein are not limited to these specific examples.

In one embodiment, the auxiliary functionality is volume control for a device (e.g., the device implementing the auxiliary functionality module 120). The auxiliary functionality module 120 increases or decreases volume based on the user input to the sensor structure 110. For example, in response to movement of the user's finger across the sensor structure 110 in one direction the module 120 increases the volume of audio output by the device, and in response to movement of the user's finger across the sensor structure 110 in another direction the module 120 decreases the volume of audio output by the device.

In another embodiment, the auxiliary functionality is game control for a device (e.g., the device implementing the auxiliary functionality module 120). The auxiliary functionality module 120 performs various operations in a game based on the user input to the sensor structure 110. The particular operation performed can vary based on the game implementation. For example, in response to movement of the user's finger across the sensor structure 110 in a particular direction the module 120 may move a character or object in the game in that particular direction.

In another embodiment, the auxiliary functionality is cursor control for a device (e.g., the device implementing the auxiliary functionality module 120). The auxiliary functionality module 120 moves a cursor or pointer on a display of the device based on the user input to the sensor structure 110. For example, in response to movement of the user's finger across the sensor structure 110 in a particular direction the module 120 moves a cursor or pointer on the display of the device in the same direction as the movement of the user's finger.

In another embodiment, the auxiliary functionality is zoom control for a device (e.g., the device implementing the auxiliary functionality module 120). The auxiliary functionality module 120 zooms in or out on the content displayed on a display of the device based on the user input to the sensor structure 110. For example, in response to movement of the user's finger across the sensor structure 110 in one direction the module 120 zooms in on the content being displayed, and in response to movement of the user's finger across the sensor structure 110 in another direction the module 120 zooms out on the content being displayed by the device.

In another embodiment, the auxiliary functionality is scroll control for a device (e.g., the device implementing the auxiliary functionality module 120). The auxiliary functionality module 120 scrolls through content displayed on a display of the device based on the user input to the sensor structure 110. For example, in response to movement of the user's finger across the sensor structure 110 in one direction the module 120 scrolls the content being displayed in one direction (e.g., up or to the left), and in response to movement of the user's finger across the sensor structure 110 in another direction the module 120 scrolls the content being displayed in another direction (e.g., down or to the right).

In another embodiment, the auxiliary functionality is menu control for a device (e.g., the device implementing the auxiliary functionality module 120). The auxiliary functionality module 120 switches through menus and/or items in a menu displayed on a display of the device based on the user input to the sensor structure 110. For example, in response to movement of the user's finger across the sensor structure 110 in one direction the module 120 switches to another menu (e.g., the next menu to the left of a currently displayed menu) or another menu item (e.g., the next menu item above the currently highlighted menu item), and in response to movement of the user's finger across the sensor structure 110 in another direction the module 120 switches to another menu (e.g., the next menu to the right of a currently displayed menu) or another menu item (e.g., the next menu item below the currently highlighted menu item).

In another embodiment, the auxiliary functionality is photography control for a device (e.g., the device implementing the auxiliary functionality module 120). The auxiliary functionality module 120 performs various operations related to image capture based on the user input to the sensor structure 110. The particular operation performed can vary based on implementation. For example, in response to movement of the user's finger across the sensor structure 110 in a particular direction the module 120 may take a picture (capture an image), zoom in or zoom out on the scene being captured, increase or decrease exposure time, and so forth.

In another embodiment, the auxiliary functionality is phone call control for a device (e.g., the device implementing the auxiliary functionality module 120). The auxiliary functionality module 120 performs various operations related to controlling phone calls based on the user input to the sensor structure 110. The particular operation performed can vary based on implementation. For example, in response to movement of the user's finger across the sensor structure 110 in a particular direction the module 120 may answer a ringing telephone, hang up on a current call, and so forth.

Although various embodiments providing different auxiliary functionality are discussed, it should be noted that multiple ones of these embodiments can be combined. System 800 can optionally include multiple auxiliary functionality modules 120, and mode selection module 804 can enable a particular one of those multiple functionality modules 120 based on a current state of the device implementing system 800, and also on contextual circumstances of receipt of the user input. The state of the device or contextual circumstances refers to one or more of a manner in which the device is currently being used, a current power state of the device, which programs are currently running on the device, which programs or functionality are available on the device, device motion, speed, where the device is located, time of day, and so forth. For example, if a game is currently being played then mode selection module 804 enables an auxiliary functionality module 120 that provides game control for the device, if the device includes phone functionality and the device is currently ringing (indicating an incoming phone call) then mode selection module 804 enables an auxiliary functionality module 120 that provides phone call control for the device.

It should also be noted that auxiliary functionality of multiple auxiliary functionality modules 120 can be implemented concurrently. For example, in response to a movement of the user's finger across the sensor structure in one dimension (e.g., horizontally, or along an x axis in a Cartesian coordinate system (e.g., the axis 204 of FIG. 2)) mode selection module 804 can enable an auxiliary functionality module 120 that provides volume control for the device implementing system 800, and in response to a movement of the user's finger across the sensor structure in a different dimension (e.g., vertically, or along a y axis in a Cartesian coordinate system (e.g., the axis 202 of FIG. 2)) mode selection module 804 can enable an auxiliary functionality module 120 that provides menu control for the device. Mode selection module 804 can determine which of multiple auxiliary functionality modules 120 to enable, or alternatively can enable multiple auxiliary functionality modules 120 and allow the individual auxiliary functionality modules 120 to decide whether to perform an operation based on the movement of the user's finger.

It should also be noted that whether the fingerprint sensor 112 operates in the high resolution mode or the low resolution mode can also be determined based on various other criteria including contextual criteria. In one embodiment, the default mode of the fingerprint sensor 112 is a high resolution mode in situations in which a user's fingerprint has not been authenticated for a current user of the system (e.g., no user is logged into the system), and the default mode of the fingerprint sensor 112 is a low resolution mode in situations in which a user's fingerprint has been authenticated for a current user of the system (e.g., a user is logged into the system).

It should also be noted that in the discussions herein, the fingerprint sensor 112 is discussed as being operable in multiple different resolution modes. It should be noted that the touch sensor 114 can optionally be operable in multiple different resolution modes. A touch sensor 114 may operate in different resolution modes for different reasons. For example, for some auxiliary functionality the touch sensor may operate in a higher resolution mode than for other auxiliary functionality.

FIG. 9 illustrates an example process 900 implementing the auxiliary device functionality augmented with fingerprint sensor in accordance with one or more embodiments. Process 900 is implemented by one or more devices or structures, such as by the device 102 of FIG. 1, by the device 302 and the sensor structure 110 of FIG. 3, and so forth. Process 900 can be implemented in software, firmware, hardware, or combinations thereof. Process 900 is shown as a set of acts and is not limited to the order shown for performing the operations of the various acts. Process 900 is an example of implementing the auxiliary device functionality augmented with fingerprint sensor discussed herein; additional discussions of implementing the auxiliary device functionality augmented with fingerprint sensor are included herein with reference to different FIGs.

In process 900, a finger touching a sensor structure that includes both a fingerprint sensor and a touch sensor is sensed (act 902). The finger can be sensed by one or both of the fingerprint sensor and the touch sensor, as discussed above.

A determination is made as to whether the fingerprint sensor or the touch sensor is touched (act 904). An indication of which of the fingerprint sensor 112 and the touch sensor 114 is touched can be obtained as discussed above, allowing this determination of whether the fingerprint sensor or the touch sensor is touched to be readily made.

A determination is also made as to whether the finger is moving across the sensor structure (act 906). This determination is made based on which of, and optionally the indications of where, the fingerprint sensor and/or touch sensor are being touched by the finger as well as the timing of those touches (or comparison of images gained or generated by the fingerprint sensor), as discussed above.

Process 900 proceeds based on whether the finger is determined to be moving across the sensor structure in act 906, as well as which of the fingerprint sensor or the touch sensor is touched.

If the fingerprint sensor senses the finger touching the sensor structure and the finger is stationary at the fingerprint sensor (and optionally in the absence of the finger touching the touch sensor), then process 900 determines that the user is touching his or her finger to the sensor structure for fingerprint authentication. Accordingly, the fingerprint identification module is powered on (act 908) and the authentication mode is enabled to attempt to authenticate the user's fingerprint (act 910). In the authentication mode, the user's fingerprint is sensed by the fingerprint sensor operating in the high resolution mode. Accordingly, if the fingerprint sensor is not already in the high resolution mode, the high resolution mode of the fingerprint sensor is activated in act 908 or 910. The attempt to authenticate the user's fingerprint can be made by comparing the user's sensed fingerprint to the fingerprint template to determine whether the sensed fingerprint satisfies the fingerprint template, and if so the user's fingerprint is authenticated as discussed above.

FIG. 10 illustrates an example scenario in which the fingerprint sensor senses the finger touching the sensor structure at the fingerprint sensor area and the finger is stationary in accordance with one or more embodiments. A finger 1002 is sensed by the fingerprint sensor 112 as touching the sensor structure 110. The finger 1002 is determined to be stationary (not moving), and thus the fingerprint identification module is powered on, the fingerprint sensor 112 is operating in the high resolution mode, and the authentication mode is enabled to attempt to authenticate a fingerprint of the finger 1002. The auxiliary functionality module need not be powered on and the auxiliary functionality mode need not be enabled to control auxiliary functionality based on movement of the user's finger.

Returning to FIG. 9, if either the fingerprint sensor or the touch sensor senses the finger touching the sensor structure, and in addition the finger is moving, then process 900 determines that the user is touching his or her finger to the sensor structure to control auxiliary functionality of the device. Accordingly, the auxiliary functionality module is powered on (act 912) and the auxiliary functionality mode is enabled to control auxiliary functionality based on movement of the user's finger (act 914). In the auxiliary functionality mode, the user's fingerprint (or finger) is sensed by the fingerprint sensor operating in the low resolution mode. Accordingly, if the fingerprint sensor is not already in the low resolution mode, the low resolution mode of the fingerprint sensor is activated in act 912 or 914. Various different auxiliary functionality can be enabled as discussed above.

FIG. 11 illustrates an example scenario in which the fingerprint sensor senses the finger touching the sensor structure and the finger is moving in accordance with one or more embodiments. A finger 1102 is sensed by the fingerprint sensor 112 as touching the sensor structure 110. The finger 1102 is determined to be moving in the direction of arrow 1104 and thus the auxiliary functionality module is powered on, the fingerprint sensor 112 is operating in the low resolution mode, and the auxiliary functionality mode is enabled to control auxiliary functionality based on movement of the user's finger. Even though the fingerprint sensor 112 is touched, the fingerprint identification module need not be powered on, the fingerprint sensor 112 need not operate in the high resolution mode, and the authentication mode need not be enabled to attempt to authenticate a fingerprint of the finger 1102.

FIG. 12 illustrates an example scenario in which the touch sensor senses the finger touching the sensor structure and the finger is moving in accordance with one or more embodiments. A finger 1202 is sensed by the touch sensor 114 as touching the sensor structure 110. The finger 1202 is determined to be moving in the direction of arrow 1204 and thus the auxiliary functionality module is powered on, the fingerprint sensor 112 is operating in the low resolution mode, and the auxiliary functionality mode is enabled to control auxiliary functionality based on movement of the user's finger. Even though the fingerprint sensor 112 is touched, the fingerprint identification module need not be powered on, the fingerprint sensor 112 need not operate in the high resolution mode, and the authentication mode need not be enabled to attempt to authenticate a fingerprint of the finger 1202.

Returning to FIG. 9, if the touch sensor senses the finger touching the sensor structure and the finger is stationary (and optionally in the absence of the finger touching the fingerprint sensor), then process 900 determines that the user is touching his or her finger to the sensor structure for neither fingerprint authentication nor to control auxiliary functionality of the device. Accordingly, neither the fingerprint identification module nor the auxiliary functionality module is powered on (act 916), and neither the authentication mode nor the auxiliary functionality mode is enabled (act 918). Because the device is not in the authentication mode, if the fingerprint sensor is not already in the low resolution mode, the low resolution mode of the fingerprint sensor is activated in act 916 or 918.

FIG. 13 illustrates an example scenario in which the touch sensor senses the finger touching the sensor structure and the finger is stationary in accordance with one or more embodiments. A finger 1302 is sensed by the touch sensor 114 as touching the sensor structure 110. The finger 1302 is determined to be stationary (not moving), and thus the auxiliary functionality module need not be powered on and the auxiliary functionality mode need not be enabled to control auxiliary functionality based on movement of the user's finger. Additionally, the fingerprint sensor 112 does not sense a fingerprint of the finger 1302, and thus the fingerprint identification module need not be powered on and the authentication mode need not be enabled to attempt to authenticate the fingerprint of the finger 1302. Furthermore, as the authentication mode need not be enabled to attempt to authenticate the fingerprint of the finger 1302, the fingerprint sensor 112 is operating in the low resolution mode.

Thus, as can be seen from the discussions herein, the auxiliary functionality is augmented with the fingerprint sensor, which allows touches to the fingerprint sensor to be used as part of the user input to control the auxiliary functionality. Although the sensor structure includes a fingerprint sensor, the fingerprint identification module need not be powered on and the authentication mode need not be enabled, and the fingerprint sensor can optionally remain in the low resolution mode, until a determination is made that a user's fingerprint is to be authenticated. This results in power and computational efficiencies because the various hardware, software, and/or firmware components (e.g., processors, algorithms, and so forth) for authenticating a fingerprint need not be powered on or otherwise activated unless a fingerprint is to be authenticated, and the high resolution mode of the fingerprint sensor need not be activated, even though the fingerprint sensor is being used to sense user inputs to control the auxiliary functionality. Furthermore, it results in an improved user experience as the area with which the user interacts is enlarged to provide improved user interaction over a relatively small fingerprint sensor area.

Similarly, although the sensor structure includes a touch sensor, the auxiliary functionality module need not be powered on and the auxiliary functionality mode need not be enabled until a determination is made that the user is touching his or her finger to the sensor structure to control auxiliary functionality of the device. This results in power and computational efficiencies because the various hardware, software, and/or firmware components (e.g., processors, algorithms, and so forth) for controlling the auxiliary functionality need not be powered or otherwise activated unless a user input to control the auxiliary functionality is to be received, even though the fingerprint sensor of the sensor structure may be being used to sense a fingerprint to be authenticated.

Various different examples of implementing the sensor structure 110 are discussed with reference to FIGS. 14-23. The examples of FIGS. 14-23 are top-down views of example sensor structures 110. It should be noted that the examples of FIGS. 14-23 are only examples, and that the sensor structure 110 can be implemented using various other configurations of fingerprint and touch sensors.

FIG. 14 illustrates an example sensor structure 110 that includes the fingerprint sensor 112 adjacent to touch sensors 114. In the illustrated example of FIG. 14, the fingerprint sensor 112 is situated between two groups of touch sensors 114, with two touch sensors 114 being situated above the fingerprint sensor 112 and two touch sensors 114 being situated below the fingerprint sensor 112.

Each of the touch sensors 114 as well as the fingerprint sensor 112 senses a user's finger touching the sensor. Each of the touch sensors 114 is implemented as a discrete sensor, and the fingerprint sensor 112 is operating in a low resolution mode as a discrete touch sensor. The sensor structure 110 can thus be treated, when operating in the auxiliary functionality mode, as a series of five discrete sensors.

FIG. 15 illustrates an example sensor structure 110 that includes the fingerprint sensor 112 adjacent to touch sensors 114. In the illustrated example of FIG. 15, the fingerprint sensor 112 is situated between two groups of touch sensors 114, with two touch sensors 114 being situated above the fingerprint sensor 112 and two touch sensors 114 being situated below the fingerprint sensor 112.

Each of the touch sensors 114 as well as the fingerprint sensor 112 senses a user's finger touching the sensor. Each of the touch sensors 114 is implemented as a discrete sensor. The fingerprint sensor 112 is operating in a low resolution mode and implemented in a grid-type arrangement as illustrated by lines 1502, 1504, and 1506.

FIG. 16 illustrates an example sensor structure 110 that includes the fingerprint sensor 112 adjacent to two touch sensors 114. In the illustrated example of FIG. 16, the fingerprint sensor 112 is situated between the two touch sensors 114, with one touch sensor 114 being situated above the fingerprint sensor 112 and one touch sensor 114 being situated below the fingerprint sensor 112.

Each of the touch sensors 114 as well as the fingerprint sensor 112 senses a user's finger touching the sensor. Each of the touch sensors 114 is implemented in a grid-type arrangement, as illustrated by the lines in the sensors 114. The fingerprint sensor 112 is operating in a low resolution mode and implemented in a grid-type arrangement as illustrated by the lines in the sensor 112.

FIG. 17 illustrates an example sensor structure 110 that includes the fingerprint sensor 112 adjacent to two touch sensors 114. In the illustrated example of FIG. 17, the fingerprint sensor 112 is situated between the two touch sensors 114, with one touch sensor 114 being situated above the fingerprint sensor 112 and one touch sensor 114 being situated below the fingerprint sensor 112.

Each of the touch sensors 114 as well as the fingerprint sensor 112 can sense a user's finger touching multiple segments or portions of the sensor, analogous to the sensor structure 110 of FIG. 16. However, the sensor structure 110 of FIG. 17 differs from the sensor structure 110 of FIG. 16 in that the fingerprint sensor 112 is operating in a high resolution mode as illustrated by the larger number of lines in the sensor 112.

FIG. 18 illustrates an example sensor structure 110 that includes the fingerprint sensor 112 adjacent to two touch sensors 114. In the illustrated example of FIG. 18, the fingerprint sensor 112 is situated between the two touch sensors 114, with one touch sensor 114 being situated above the fingerprint sensor 112 and one touch sensor 114 being situated below the fingerprint sensor 112.

Each of the touch sensors 114 as well as the fingerprint sensor 112 senses a user's finger touching the sensor. Each of the touch sensors 114 is implemented in a grid-type arrangement, as illustrated by the lines in the sensors 114. The fingerprint sensor 112, however, is operating in a low resolution mode as a discrete touch sensor.

In the example sensor structures 110 of FIGS. 14-18, the touch sensors 114 are illustrated as being situated above or below the fingerprint sensor 112. However, it should be noted that any of a variety of other configurations of touch sensors 114 relative to the fingerprint sensor 112 can be implemented.

FIG. 19 illustrates an example sensor structure 110 that includes the fingerprint sensor 112 adjacent to touch sensors 114. In the illustrated example of FIG. 19, the fingerprint sensor 112 is situated between two groups of touch sensors 114, with two touch sensors 114 being situated to the left of the fingerprint sensor 112 and two touch sensors 114 being situated to the right of the fingerprint sensor 112.

The touch sensors 114 may be discrete sensors analogous to the sensor structures 110 of FIGS. 14 and 15 discussed above, or alternatively any one or more of the touch sensors 114 may be implemented in a grid-type arrangement analogous to the sensor structures 110 of FIGS. 16, 17, and 18 discussed above. The fingerprint sensor 112 can operate in a low resolution mode (analogous to the sensor structures 110 of FIGS. 14, 15, 16, and 18 discussed above) or in a high resolution mode (analogous to the sensor structure 110 of FIG. 17 discussed above).

It should be noted that, in situations in which the implemented grid-type arrangement of the fingerprint sensor 112 is denser (a larger number of pixels or nodes per inch) than the implemented grid-type arrangement or discrete sensor of the touch sensors 114, care may be taken to provide a smooth user experience. For example, in the sensor structure 110 of FIG. 17 in which the fingerprint sensor 112 is operating in a high resolution mode, care may be taken to translate or convert multiple different pixels or nodes of the fingerprint sensor 112 to a smaller number of pixels or nodes, resulting in a number of pixels or nodes that can be sensed by the fingerprint sensor 112 being approximately the same as the number of pixels or nodes that can be sensed the implemented grid-type arrangement or discrete sensor of the touch sensors 114.

FIGS. 20, 21, 22, and 23 each illustrate a different example sensor structure 110 that includes the fingerprint sensor 112 surrounded by and adjacent to touch sensors 114. These different example sensor structures illustrate different shapes and/or arrangements of sensors in a sensor structure 110. The touch sensors 114 of the different sensor structures 110 may be discrete sensors analogous to the sensor structures 110 of FIGS. 14 and 15 discussed above, or alternatively may be implemented in a grid-type arrangement analogous to the sensor structures 110 of FIGS. 16, 17, and 18 discussed above. The fingerprint sensors 112 of the different sensor structures 110 can operate in a low resolution mode (analogous to the sensor structures 110 of FIGS. 14, 15, 16, and 18 discussed above) or in a high resolution mode (analogous to the sensor structure 110 of FIG. 17 discussed above).

FIG. 24 illustrates various components of an example electronic device 2400 that can be implemented as a device as described with reference to any of the previous FIGS. 1-23. The device 2400 may be implemented as any one or combination of a fixed or mobile device, in any form of a consumer, computer, portable, wearable, user, communication, phone, navigation, gaming, messaging, Web browsing, paging, media playback, and/or other type of electronic device.

The electronic device 2400 can include one or more data input ports 2402 via which any type of data, media content, and/or inputs can be received, such as user-selectable inputs, messages, music, television content, recorded video content, and any other type of audio, video, and/or image data received from any content and/or data source. The data input ports 2402 may include USB ports, coaxial cable ports, and other serial or parallel connectors (including internal connectors) for flash memory, DVDs, CDs, and the like. These data input ports may be used to couple the electronic device to components, peripherals, or accessories such as keyboards, microphones, or cameras.

The electronic device 2400 of this example includes a processor system 2404 (e.g., any of microprocessors, controllers, and the like), or a processor and memory system (e.g., implemented in an SoC), which process computer-executable instructions to control operation of the device. A processing system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the electronic device can be implemented with any one or combination of software, hardware, firmware, or fixed logic circuitry that is implemented in connection with processing and control circuits, which are generally identified at 2406. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 2400 also includes one or more memory devices 2408 that enable data storage, examples of which include random access memory (RAM), non-volatile memory (e.g., read-only memory (ROM), flash memory, EPROM, EEPROM, etc.), and a disk storage device. A memory device 2408 provides data storage mechanisms to store the device data 2410, other types of information and/or data, and various device applications 2412 (e.g., software applications). For example, an operating system 2414 can be maintained as software instructions with a memory device and executed by the processor system 2404.

In embodiments, the electronic device 2400 includes a sensor based control system 116, a fingerprint identification module 118, and an auxiliary functionality module 120 as described above. Although represented as a software implementation, each of the sensor based control system 116, the fingerprint identification module 118, and the auxiliary functionality module 120 may be implemented as any form of a control application, software application, signal-processing and control module, firmware that is installed on the device, a hardware implementation, and so on. The electronic device 2400 can also include a sensor structure 110 as described above.

The electronic device 2400 can also include an audio and/or video processing system 2420 that processes audio data and/or passes through the audio and video data to an audio system 2422 and/or to a display system 2424. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 2426. In implementations, the audio system and/or the display system are external components to the electronic device. Alternatively or in addition, the display system can be an integrated component of the example electronic device, such as part of an integrated touch interface.

Although embodiments of auxiliary device functionality augmented with fingerprint sensor have been described in language specific to features and/or methods, the subject of the appended claims is not necessarily limited to the specific features or methods described. Rather, the specific features and methods are disclosed as example implementations of auxiliary device functionality augmented with fingerprint sensor.

1. A method comprising:
sensing a finger touching a sensor structure, the sensor structure including both a fingerprint sensor and a touch sensor adjacent to the fingerprint sensor and in a same plane as the fingerprint sensor;
determining whether the finger is moving across the sensor structure or is stationary;
enabling an authentication mode to attempt to authenticate a fingerprint of the finger in response to both sensing the finger touching the fingerprint sensor and determining the finger is stationary; and
enabling an auxiliary functionality mode to control auxiliary functionality of a device based on movement of the finger across the sensor structure in response to both sensing the finger touching the fingerprint sensor and determining the finger is moving across the sensor structure.

2. The method as recited in claim 1, further comprising:
enabling the auxiliary functionality mode in response to both sensing the finger touching the touch sensor and determining the finger is moving across the sensor structure.

3. The method as recited in claim 2, further comprising:
enabling neither the auxiliary functionality mode nor the authentication mode in response to both sensing the finger touching the touch sensor and determining the finger is stationary.

4. The method as recited in claim 1, the determining comprising determining that the finger is moving across the sensor structure in response to both the fingerprint sensor and the touch sensor sensing the finger within a threshold amount of time of one another.

5. The method as recited in claim 1, wherein enabling the authentication mode includes initiating and powering on a fingerprint identification module including one or more processors and algorithms.

6. The method as recited in claim 1, wherein the auxiliary functionality mode comprises a volume control mode in which movement of the finger across the sensor structure is used as volume control input.

7. The method as recited in claim 1, wherein:
the auxiliary functionality mode comprises game control, cursor control, zoom control, scroll control, menu control, photography control, or phone call control; and
the movement of the finger across the sensor structure is used by an auxiliary functionality module to determine an operation being requested by the user.

8. The method as recited in claim 1, the determining comprising determining that the finger is stationary in response to the fingerprint sensor sensing the finger and the absence of the finger touching the touch sensor.

9. A system comprising:
a sensor structure including both a fingerprint sensor and a touch sensor adjacent to the fingerprint sensor and in a same plane as the fingerprint sensor; and
a control system configured to activate, based on both whether a finger detected by the sensor structure is moving across the sensor structure and which of the fingerprint sensor and the touch sensor senses the finger touching the sensor structure, a fingerprint identification module to attempt to authenticate a fingerprint of the finger using the fingerprint sensor, or an auxiliary functionality module to control auxiliary functionality of the system based on the movement of the finger across the sensor structure.

10. The system as recited in claim 9, the control system being configured to activate the fingerprint identification module in response to the finger being stationary.

11. The system as recited in claim 9, the control system being further configured to activate the fingerprint identification module including one or more processors and algorithms in response to the finger being sensed touching the sensor structure by the fingerprint sensor and the finger being stationary.

12. The system as recited in claim 9, the control system being further configured to activate the auxiliary functionality module including one or more processors and algorithms in response to the finger being sensed as moving across one or both of the fingerprint sensor and the touch sensor.

13. The system as recited in claim 12, the control system being further configured to leave the fingerprint identification module including one or more processors and algorithms powered down in response to the finger being sensed as moving across one or both of the fingerprint sensor and the touch sensor.

14. The system as recited in claim 9, the control system being further configured to determine that the finger is moving across the sensor structure in response to the finger being sensed touching the sensor structure by both the fingerprint sensor and the touch sensor within a threshold amount of time of one another.

15. The system as recited in claim 9, the auxiliary functionality comprising volume control, game control, cursor control, zoom control, scroll control, menu control, photography control, or phone call control.

16. A system comprising:
a sensor structure including both a fingerprint sensor and a touch sensor, the touch sensor being adjacent to the fingerprint sensor; and
a control system configured to power on a fingerprint identification module to attempt to authenticate a fingerprint of a finger sensed by the sensor structure in response to both the finger being determined to be stationary and the finger being sensed as touching the sensor structure by the fingerprint sensor.

17. The system as recited in claim 16, the control system being further configured to activate an auxiliary functionality module to control auxiliary functionality of the system in response to the finger being determined to be moving and being sensed as touching the sensor structure by the fingerprint sensor or the touch sensor.

18. The system as recited in claim 17, the auxiliary functionality module comprising a volume control module, a game control module, a cursor control module, a zoom control module, a scroll control module, a menu control module, a photography control module, or a phone call control module.

19. The system as recited in claim 17, the control system being further configured to activate neither the auxiliary functionality module nor the fingerprint identification module in response to both the finger being determined to be stationary and being sensed as touching the sensor structure by the touch sensor.

20. The system as recited in claim 16, the control system being further configured to enable a high resolution mode of the fingerprint sensor in response to both the finger being determined to be stationary and the finger being sensed as touching the sensor structure by the fingerprint sensor.
